(19) United States
(12) Patent Application Publication
(10) Pub. No.: US 2010/0008293 A1
(43) Pub. Date: Jan. 14, 2010

(54) X2 INTERFACES FOR ACCESS POINT BASE STATIONS IN SELF-ORGANIZING NETWORKS (SON)

(75) Inventors: Rajarshi Gupta, Santa Clara, CA (US); Parag A. Agashe, San Diego, CA (US); Peerapol Tinnakornsrisuphap, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/498,263

(22) Filed: Jul. 6, 2009

Related U.S. Application Data
(60) Provisional application No. 61/079,353, filed on Jul. 9, 2008.

(51) Int. Cl. H04W 92/00

(52) U.S. Cl. 370/328

(57) ABSTRACT

Systems and methodologies are described that facilitate leveraging an X2-AP interface for data exchange between an access terminal and a Home access terminal. Based upon a received request from a Home access terminal, the access terminal can activate an X2-AP interface connection on demand over Stream Control Transmission Protocol (SCTP) based upon a maximum number of connections not being met and/or a timer evaluation that indicates the request is within an allowed time period. The capacity of the access terminal related to the amount of X2-AP connections can be managed based upon at least one of a timer evaluation, or a maximum number of X2-AP connections. The systems and methodologies provide an optimal and efficient technique in order to enable data to be exchanged between an access terminal and a Home access terminal utilizing an X2-AP interface.

### CROSS-REFERENCE TO RELATED APPLICATIONS

This application claims the benefit of U.S. Provisional Patent application Ser. No. 61/079,353 entitled “X2 INTERFACES FOR ACCESS POINT BASE STATIONS IN SELF-ORGANIZING NETWORKS (SON)” which was filed Jul. 9, 2008. The entirety of the aforementioned application is herein incorporated by reference.

### BACKGROUND

I. Field

The following description relates generally to wireless communications, and more particularly exchanging information between an eNB and a HeNB utilizing an X2-AP interface.

II. Background

Wireless communication systems are widely deployed to provide various types of communication; for instance, voice and/or data can be provided via such wireless communication systems. A typical wireless communication system, or network, can provide multiple users access to one or more shared resources (e.g., bandwidth, transmit power, . . . ). For instance, a system can use a variety of multiple access techniques such as Frequency Division Multiplexing (FDM), Time Division Multiplexing (TDM), Code Division Multiplexing (CDM), Orthogonal Frequency Division Multiplexing (OFDM), and others.

Generally, wireless multiple-access communication systems can simultaneously support communication for multiple mobile devices. Each mobile device can communicate with one or more base stations via transmissions on forward and reverse links. The forward link (or downlink) refers to the communication link from base stations to mobile devices, and the reverse link (or uplink) refers to the communication link from mobile devices to base stations.

Wireless communication systems oftentimes employ one or more base stations that provide a coverage area. A typical base station can transmit multiple data streams for broadcast, multicast and/or unicast services, wherein a data stream may be a stream of data that can be of independent reception interest to a mobile device. A mobile device within the coverage area of such base station can be employed to receive one, more than one, or all the data streams carried by the composite stream. Likewise, a mobile device can transmit data to the base station or another mobile device.

An X2-Application Protocol (X2-AP) is an interface between eNBs. Traditionally, the X2-APP interface is utilized to exchange or share information during Automatic Neighbor Relation (ANR). Additionally, the X2-AP interface can perform handover of a User Equipment (UE) from one eNB to another eNB. Typically, an eNB can set up the X2-AP interface and maintain X2-AP interface(s) with neighboring eNBs. In general, the X2-AP interface is a control plane protocol that can support load management and handover coordination between eNBs.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

According to related aspects, a method that facilitates utilizing an interface to exchange data. The method can include receiving an on demand request from an access point base station upon a start up of the access point base station, wherein the request relates to initiating an interface to exchange data. Further, the method can include denying the request based upon at least one of a resource constraint or a timer constraint. Moreover, the method can comprise utilizing an interface to exchange data between the access point base station and an access terminal when at least one of the resource constraint or the timer constraint are met.

Another aspect relates to a wireless communications apparatus. The wireless communications apparatus can include at least one processor configured to receive a request from an access point base station upon a start up of the access point base station, wherein the request relates to initiating an interface to exchange data, denying the request based upon at least one of a timer constraint or a resource constraint, and utilizing an interface over Stream Control Transmission Protocol (SCTP) to exchange data between the access point base station and an access terminal when at least one of the resource constraint or the timer constraint are met. Further, the wireless communications apparatus can include memory coupled to the at least one processor.

Yet another aspect relates to a wireless communications apparatus that enables utilization of an interface to exchange data in a wireless communication network. The wireless communications apparatus can include means for means for receiving an on demand request from a Home access terminal upon a start up of the access point base station, wherein the request relates to initiating an interface to exchange data. Additionally, the wireless communications apparatus can comprise means for denying the request based upon at least one of a timer constraint or a resource constraint. Further, the wireless communications apparatus can comprise means for utilizing an interface to exchange data between the access point base station and an access terminal when the resource constraint and the timer constraint are met.

Still another aspect relates to a computer program product comprising a computer-readable medium having stored thereon code to receive a request from an access point base station upon a start up of the access point base station, wherein the request relates to initiating an interface to exchange data, code for causing at least one computer to deny the request based upon at least one of a timer constraint or a resource constraint, and code for causing at least one computer to utilizing an interface to exchange data between the access point base station and an access terminal when the timer constraint and the resource constraint are met.

According to other aspects, a method that facilitates utilizing an interface to exchange data. The method can comprise transmitting a request to an access terminal upon a start up of an access point base station, wherein the request relates to initiating an interface to exchange data. Further, the method can comprise receiving a denial for the request based upon of at least one of a resource constraint or a timer constraint. Moreover, the method can include utilizing an interface over Stream Control Transmission Protocol (SCTP) to exchange data between an access point base station and the access terminal when the resource constraint and the timer constraint are met.

Another aspect relates to a wireless communications apparatus. The wireless communications apparatus can include at least one processor configured to transmit a request to an access terminal upon a start up of an access point base station, wherein the request relates to initiating an interface to exchange data, receive a denial for the request based upon at least one of a timer constraint or a resource constraint, and utilize an interface to exchange data between an access point base station and the access terminal when the time constraint and the resource constraint are met. Further, the wireless communications apparatus can include memory coupled to the at least one processor.

Another aspect relates to a wireless communications apparatus that enables employment of an interface to exchange data. The wireless communications apparatus can comprise means for transmitting a request to an access terminal upon a start up of an access point base station, wherein the request relates to initiating an interface to exchange data. Moreover, the wireless communications apparatus can comprise means for receiving a denial for the request based upon at least one of a timer constraint or a resource constraint. Further, the wireless communications apparatus can include means for utilizing an interface to exchange data between an access point base station and the access terminal when the maximum number of connection is not reached and the evaluation of the timer indicates the received request is within an allowed time period.

Still another aspect relates to a computer program product comprising a computer-readable medium having stored thereon code for causing at least one computer to transmit a request to an access terminal upon a start up of an access point base station, wherein the request relates to initiating an interface to exchange data, code for causing at least one computer to receive a denial for the request based upon at least one of a timer constraint or a resource constraint, and code for causing at least one computer to utilize an interface over Stream Control Transmission Protocol (SCTP) to exchange data between an access point base station and the access terminal when the resource constraint and the timer constraint are met.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments can be employed and the described embodiments are intended to include all such aspects and their equivalents.

### BRIEF DESCRIPTION OF THE DRAWINGS

FIG. 1 is an illustration of a wireless communication system in accordance with various aspects set forth herein.

FIG. 2 illustrates an exemplary wireless communication system.

FIG. 3 illustrates an exemplary communication system to enable deployment of access point base stations within a network environment.

FIG. 4 is an illustration of an example communications apparatus for employment within a wireless communications environment.

FIG. 5 is an illustration of an example wireless communications system that facilitates utilizing an interface to exchange data between a Home eNodeB and a base station.

FIG. 6 is an illustration of an example methodology that initializes an X2-AP interface over SCTP based upon a received request.

FIG. 7 is an illustration of an example methodology that leverages an X2-AP interface to communicate data between a Home eNodeB and an eNodeB.

FIG. 8 is an illustration of an example mobile device that facilitates communicating data in a wireless communication system in accordance with the subject innovation.

FIG. 9 is an illustration of an example system that facilitates managing an X2-AP interface for data exchange in a wireless communication environment.

FIG. 10 is an illustration of an example wireless network environment that can be employed in conjunction with the various systems and methods described herein.

FIG. 11 is an illustration of an example system that facilitates managing an X2-AP interface for data exchange between a Home eNodeB and an eNodeB.

FIG. 12 is an illustration of an example system that employs an X2-AP interface for data exchange based upon a transmitted request in a wireless communication environment.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

As used in this application, the terms “module,” “component,” “interface,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

The techniques described herein can be used for various wireless communication systems such as code division multiple access (CDMA), time division multiple access (TDMA), frequency division multiple access (FDMA), orthogonal frequency division multiple access (OFDMA), single carrier-frequency division multiple access (SC-FDMA) and other systems. The terms “system” and “network” are often used interchangeably. A CDMA system can implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink.

Single carrier frequency division multiple access (SC-FDMA) utilizes single carrier modulation and frequency domain equalization. SC-FDMA has similar performance and essentially the same overall complexity as those of an OFDMA system. A SC-FDMA signal has lower peak-to-average power ratio (PAPR) because of its inherent single carrier structure. SC-FDMA can be used, for instance, in uplink communications where lower PAPR greatly benefits access terminals in terms of transmit power efficiency. Accordingly, SC-FDMA can be implemented as an uplink multiple access scheme in 3GPP Long Term Evolution (LTE) or Evolved UTRA.

Furthermore, various embodiments are described herein in connection with a mobile device. A mobile device can also be called a system, subscriber unit, subscriber station, mobile station, mobile, remote station, remote terminal, access terminal, user terminal, terminal, wireless communication device, user agent, user device, or user equipment (UE). A mobile device can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with mobile device(s) and can also be referred to as an access point, Node B, or some other terminology.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

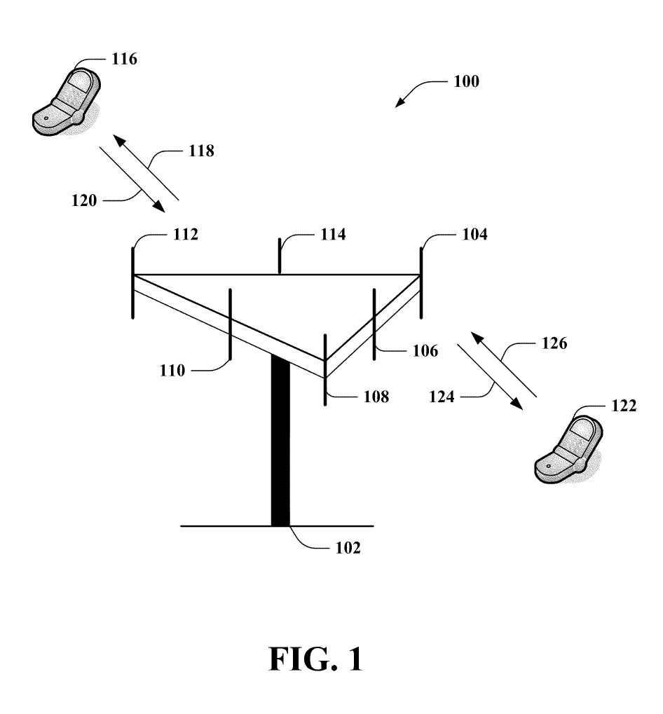

Referring now to FIG. 1, a wireless communication system 100 is illustrated in accordance with various embodiments presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more mobile devices such as mobile device 116 and mobile device 122; however, it is to be appreciated that base station 102 can communicate with substantially any number of mobile devices similar to mobile devices 116 and 122. Mobile devices 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, mobile device 116 is in communication with antennas 112 and 114, where antennas 112 and 114 transmit information to mobile device 116 over a forward link 118 and receive information from mobile device 116 over a reverse link 120. Moreover, mobile device 122 is in communication with antennas 104 and 106, where antennas 104 and 106 transmit information to mobile device 122 over a forward link 124 and receive information from mobile device 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

Each group of antennas and/or the area in which they are designated to communicate can be referred to as a sector of base station 102. For example, antenna groups can be designed to communicate to mobile devices in a sector of the areas covered by base station 102. In communication over forward links 118 and 124, the transmitting antennas of base station 102 can utilize beamforming to improve signal-to-noise ratio of forward links 118 and 124 for mobile devices 116 and 122. Also, while base station 102 utilizes beamforming to transmit to mobile devices 116 and 122 scattered randomly through an associated coverage, mobile devices in neighboring cells can be subject to less interference as compared to a base station transmitting through a single antenna to all its mobile devices.

Base station 102 (and/or each sector of base station 102) can employ one or more multiple access technologies (e.g., CDMA, TDMA, FDMA, OFDMA, . . . ). For instance, base station 102 can utilize a particular technology for communicating with mobile devices (e.g. mobile devices 116 and 122) upon a corresponding bandwidth. Moreover, if more than one technology is employed by base station 102, each technology can be associated with a respective bandwidth. The technologies described herein can include following: Global System for Mobile (GSM), General Packet Radio Service (GPRS), Enhanced Data Rates for GSM Evolution (EDGE), Universal Mobile Telecommunications System (UMTS), Wideband Code Division Multiple Access (W-CDMA), cdmaOne (IS-95), CDMA2000, Evolution-Data Optimized (EV-DO), Ultra Mobile Broadband (UMB), Worldwide Interoperability for Microwave Access (WiMAX), MediaFLO, Digital Multimedia Broadcasting (DMB), Digital Video Broadcasting-Handheld (DVB-H), etc. It is to be appreciated that the aforementioned listing of technologies is provided as an example and the claimed subject matter is not so limited; rather, substantially any wireless communication technology is intended to fall within the scope of the hereto appended claims.

Base station 102 can employ a first bandwidth with a first technology. Moreover, base station 102 can transmit a pilot corresponding to the first technology on a second bandwidth. According to an illustration, the second bandwidth can be leveraged by base station 102 and/or any disparate base station (not shown) for communication that utilizes any second technology. Moreover, the pilot can indicate the presence of the first technology (e.g., to a mobile device communicating via the second technology). For example, the pilot can use bit(s) to carry information about the presence of the first technology. Additionally, information such as a SectorID of the sector utilizing the first technology, a CarrierIndex indicating the first frequency bandwidth, and the like can be included in the pilot.

According to another example, the pilot can be a beacon (and/or a sequence of beacons). A beacon can be an OFDM symbol where a large fraction of the power is transmitted on one subcarrier or a few subcarriers (e.g. small number of subcarriers). Thus, the beacon provides a strong peak that can be observed by mobile devices, while interfering with data on a narrow portion of bandwidth (e.g., the remainder of the bandwidth can be unaffected by the beacon). Following this example, a first sector can communicate via CDMA on a first bandwidth and a second sector can communicate via OFDM on a second bandwidth. Accordingly, the first sector can signify the availability of CDMA on the first bandwidth (e.g., to mobile device(s) operating utilizing OFDM on the second bandwidth) by transmitting an OFDM beacon (or a sequence of OFDM beacons) upon the second bandwidth.

The subject innovation can leverage an X2-AP interface in order to enable the communication of data between a Home eNodeB (HeNB) and an eNodeB (eNB). Such employment of the X2-AP interface for data exchange can be optimized by enabling connectivity based upon at least one of a timer evaluation or a number of connections. In particular, a timer can restrict particular hours or times that the X2-AP interface may not be utilized for connectivity. In another instance, the timer can be implemented that upon expiration, the X2-AP interface connection can be terminated. For example, the timer can be defined to enable the HeNB to exchange data with the X2-AP interface during setup or start up of the HeNB. Thus, once the setup or start up of the HeNB is complete, the X2-AP interface can be terminated—this can allow a restricted time period that the X2-AP interface can be utilized for a HeNB. Moreover, the number of active connections can be defined in order to ensure that there is not overload for the number of active connections between an eNB and HeNBs. For example, the eNB can have a number of active connections or requests that can be employed during an instance, and requests for additional connections to the eNB can be denied if such number is met. In still another example, the eNB can leverage a priority technique in which various levels of priority can be assigned to at least one of eNBs or HeNBs (discussed in more detail below). Thus, based on such priority levels, connectivity requests can be denied or accepted.

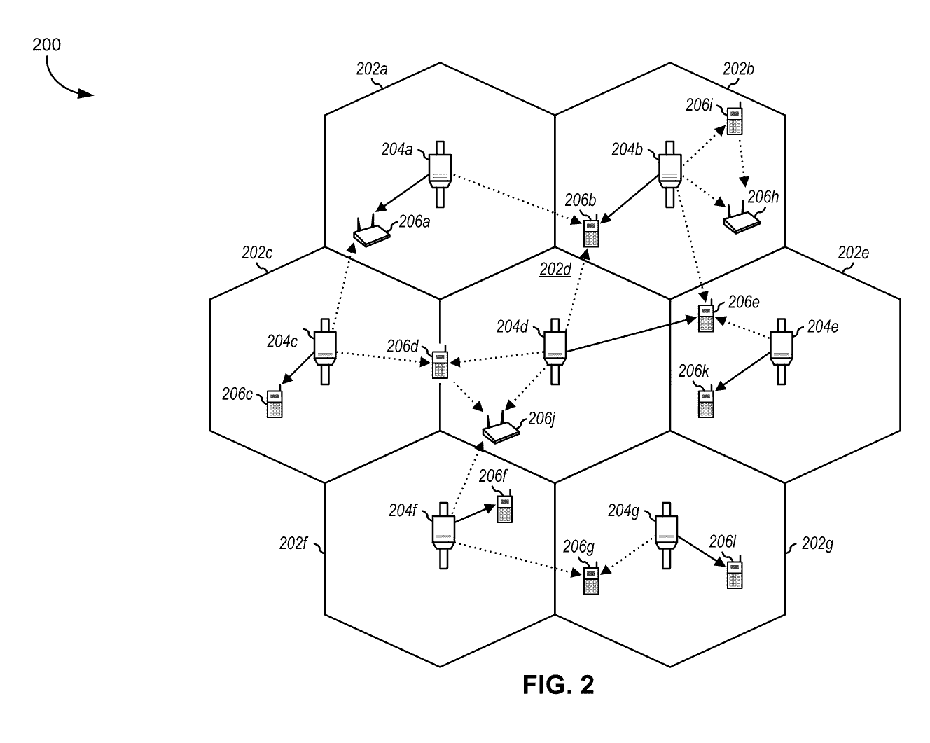

FIG. 2 illustrates an exemplary wireless communication system 200 configured to support a number of users, in which various disclosed embodiments and aspects may be implemented. As shown in FIG. 2, by way of example, system 200 provides communication for multiple cells 202, such as, for example, macro cells 202a-202g, with each cell being serviced by a corresponding access point (AP) 204 (such as APs 204a-204g). Each cell may be further divided into one or more sectors. Various access terminals (ATs) 206, including ATs 206a-206k, also known interchangeably as user equipment (UE) or mobile stations, are dispersed throughout the system. Each AT 206 may communicate with one or more APs 204 on a forward link (FL) and/or a reverse link (RL) at a given moment, depending upon whether the AT is active and whether it is in soft handoff, for example. The wireless communication system 200 may provide service over a large geographic region, for example, macro cells 202a-202g may cover a few blocks in a neighborhood.

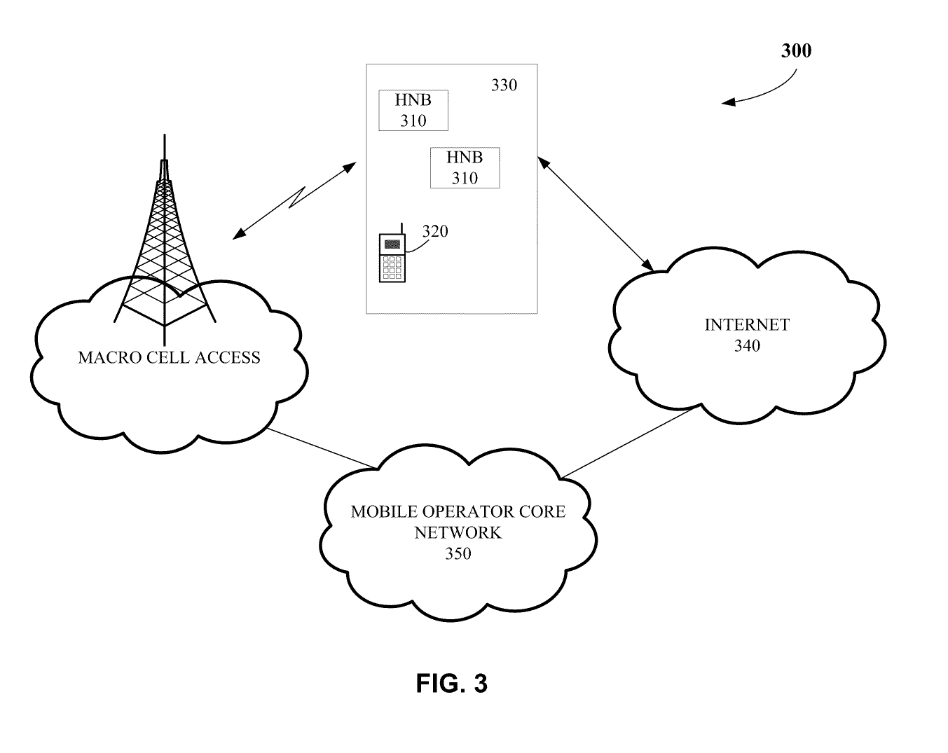

FIG. 3 illustrates an exemplary communication system to enable deployment of access point base stations within a network environment. As shown in FIG. 3, the system 300 includes multiple access point base stations or Home Node B units (HNBs) or femto cells, such as, for example, HNBs 310, each being installed in a corresponding small scale network environment, such as, for example, in one or more user residences 330, and being configured to serve associated, as well as alien, user equipment (UE) 320. Each HNB 310 is further coupled to the Internet 340 and a mobile operator core network 350 via a DSL router (not shown) or, alternatively, a cable modem (not shown). Specifically, the system 300 can include multiple femto nodes (also referred to as HNB 310) installed in a relatively small scale network environment (e.g., in one or more user residences). Each femto node may be coupled to a wide area network 340 (e.g., the Internet) and a mobile operator core network 350 via a DSL router, a cable modem, a wireless link, or other connectivity means (not shown). As will be discussed below, each femto node may be configured to serve associated access terminals 320 (e.g., access terminal 1920A) and, optionally, alien access terminals (e.g., not shown). In other words, access to femto nodes may be restricted whereby a given access terminal 320 may be served by a set of designated (e.g., home) femto node(s) but may not be served by any non-designated femto nodes (e.g., a neighbor's femto node).

Although embodiments described herein use 3GPP terminology, it is to be understood that the embodiments may be applied to 3GPP (Rel99, Rel5, Rel6, Rel7, Rel 8, Rel 9, Rel 10) technology, as well as 3GPP2 (1×RTT, 1×EV-DO Rel0, RevA, RevB) technology and other known and related technologies. In such embodiments described herein, the owner of the HNB 310 subscribes to mobile service, such as, for example, 3G mobile service, offered through the mobile operator core network 350, and the UE 320 is capable to operate both in macro cellular environment and in residential small scale network environment. Thus, the HNB 310 is backward compatible with any existing UE 320.

Moreover, a coverage map can include several tracking areas (or routing areas or location areas) are defined, each of which includes several macro coverage areas. Areas of coverage associated with tracking areas A, B, and C can be wide lines and the macro coverage areas can be represented by the hexagons. The tracking areas also include femto coverage areas. For example, each of the femto coverage areas (e.g., femto coverage area C) can be depicted within a macro coverage area. It should be appreciated, however, that a femto coverage area may not lie entirely within a macro coverage area. In practice, a large number of femto coverage areas may be defined with a given tracking area or macro coverage area. Also, one or more pico coverage areas (not shown) may be defined within a given tracking area or macro coverage area.

The owner of a femto node may subscribe to mobile service, such as, for example, 3G mobile service, offered through the mobile operator core network 350. In addition, an access terminal 320 may be capable of operating both in macro environments and in smaller scale (e.g., residential) network environments. In other words, depending on the current location of the access terminal 320, the access terminal 320 may be served by an access node (e.g., access node resource) of the macro cell mobile network 350 or by any one of a set of femto nodes (e.g., the femto nodes and that reside within a corresponding user residence 330). For example, when a subscriber is outside his home, he is served by a standard macro access node and when the subscriber is at home, he is served by a femto node. Here, it should be appreciated that a femto node may be backward compatible with existing access terminals 320.

A femto node may be deployed on a single frequency or, in the alternative, on multiple frequencies. Depending on the particular configuration, the single frequency or one or more of the multiple frequencies may overlap with one or more frequencies used by a macro node.

In some aspects, an access terminal 320 may be configured to connect to a preferred femto node (e.g., the home femto node of the access terminal 320) whenever such connectivity is possible. For example, whenever the access terminal 320 is within the user's residence 330, it may be desired that the access terminal 320 communicate only with the home femto node.

In some aspects, if the access terminal 320 operates within the macro cellular network 350 but is not residing on its most preferred network (e.g., as defined in a preferred roaming list), the access terminal 320 may continue to search for the most preferred network (e.g., the preferred femto node) using a Better System Reselection (“BSR”), which may involve a periodic scanning of available systems to determine whether better systems are currently available, and subsequent efforts to associate with such preferred systems. With the acquisition entry, the access terminal 320 may limit the search for specific band and channel. For example, the search for the most preferred system may be repeated periodically. Upon discovery of a preferred femto node, the access terminal 320 selects the femto node for camping within its coverage area.

A femto node may be restricted in some aspects. For example, a given femto node may only provide certain services to certain access terminals. In deployments with so-called restricted (or closed) association, a given access terminal may only be served by the macro cell mobile network and a defined set of femto nodes (e.g., the femto nodes that reside within the corresponding user residence 330). In some implementations, a node may be restricted to not provide, for at least one node, at least one of: signaling, data access, registration, paging, or service.

In some aspects, a restricted femto node (which may also be referred to as a Closed Subscriber Group Home NodeB) is one that provides service to a restricted provisioned set of access terminals. This set may be temporarily or permanently extended as necessary. In some aspects, a Closed Subscriber Group (“CSG”) may be defined as the set of access nodes (e.g., femto nodes) that share a common access control list of access terminals. A channel on which all femto nodes (or all restricted femto nodes) in a region operate may be referred to as a femto channel.

Various relationships may thus exist between a given femto node and a given access terminal. For example, from the perspective of an access terminal, an open femto node may refer to a femto node with no restricted association. A restricted femto node may refer to a femto node that is restricted in some manner (e.g., restricted for association and/or registration). A home femto node may refer to a femto node on which the access terminal is authorized to access and operate on. A guest femto node may refer to a femto node on which an access terminal is temporarily authorized to access or operate on. An alien femto node may refer to a femto node on which the access terminal is not authorized to access or operate on, except for perhaps emergency situations (e.g., 911 calls).

From a restricted femto node perspective, a home access terminal may refer to an access terminal that authorized to access the restricted femto node. A guest access terminal may refer to an access terminal with temporary access to the restricted femto node. An alien access terminal may refer to an access terminal that does not have permission to access the restricted femto node, except for perhaps emergency situations, for example, such as 911 calls (e.g., an access terminal that does not have the credentials or permission to register with the restricted femto node).

For convenience, the disclosure herein describes various functionality in the context of a femto node. It should be appreciated, however, that a pico node may provide the same or similar functionality for a larger coverage area. For example, a pico node may be restricted, a home pico node may be defined for a given access terminal, and so on.

A wireless multiple-access communication system may simultaneously support communication for multiple wireless access terminals. As mentioned above, each terminal may communicate with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out system, a multiple-in-multiple-out (“MIMO”) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (“TDD”) and frequency division duplex (“FDD”). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

The teachings herein may be incorporated into a node (e.g., a device) employing various components for communicating with at least one other node.

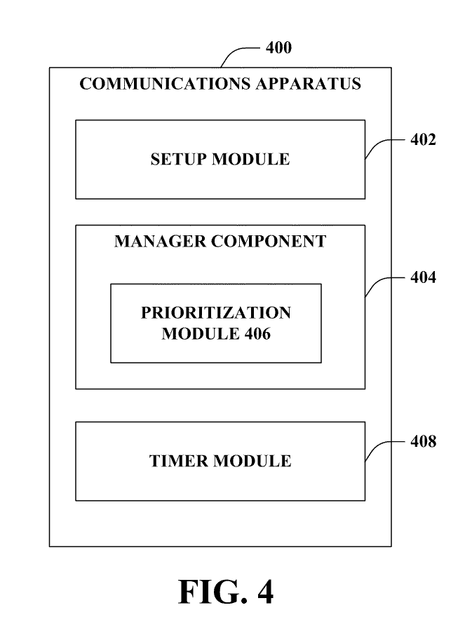

Turning to FIG. 4, illustrated is a communications apparatus 400 for employment within a wireless communications environment. The communications apparatus 400 can be a base station or a portion thereof, an eNode B or a portion thereof, a node B or a portion thereof, a macro cell or a portion thereof, a Home Node B or a portion thereof, a Home eNode B or a portion thereof, a mobile device or a portion thereof, or substantially any communications apparatus that receives data transmitted in a wireless communications environment. In communications systems, the communications apparatus 400 employ components described below in order to effectively and optimally leverage an X2-AP interface to exchange data.

The communications apparatus 400 can include a setup module 402 that can initiate an X2-AP interface based upon a received request from a Home eNodeB during start up. For example, the setup module 402 can evaluate requests in order to identify whether to employ an X2-AP interface for data exchange between the Home eNodeB and an eNodeB. Yet, the setup module 402 can deny requests for the X2-AP connection based at least in part upon a timer evaluation and/or a maximum number of X2-AP connections. In particular, a timer can restrict particular hours or times that the X2-AP interface may not be utilized for connectivity. For instance, if a request for an X2-AP interface is received during a restricted or prohibited time and/or the maximum number of X2-AP connections is met, the request can be denied. The communication apparatus 400 can further include a manager component 404 that can administrate or manage the implementation of an X2-AP interface for data exchange between the Home eNodeB and the eNodeB. For example, the manager component 404 can manage the initialization, denial, and/or termination of the X2-AP interface based upon a timer evaluation, a number of requests and/or established X2-AP interfaces. It is to be appreciated that the manager component 404 can enforce a number of requests or established X2-AP interfaces (e.g., maximum number, minimum number, etc.) for an eNodeB. In other words, the subject innovation can evaluate a timer and/or a maximum number of X2-AP connections and deny a request. Moreover, the subject innovation can terminate an existing X2-AP connection in order to establish an X2-AP interface based upon defined priorities (discussed below).

The manager component 404 can further include a prioritization module 406 that can evaluate prioritization rankings related to eNodeBs and/or Home eNodeBs in order to optimally initiate or implement an X2-AP interface for data exchange in light of the defined number of requests or interfaces enabled. For instance, the prioritization module 406 can initiate, deny, or terminate an X2-AP interface based upon the priority ranking. For example, an eNodeB can have a priority list with various eNodeBs ranked in priority. Thus, if a first eNodeB is at capacity (e.g., number of requests or established X2-AP interfaces) and a request is received from a second eNodeB, the ranking can be evaluated. If the request from the second eNodeB has a higher ranking priority than a current established interface or received request, the first eNodeB can terminate a current established interface or request in order to handle the higher ranking priority request of the eNodeB.

Moreover, the example can be extended to priority rankings of Home eNodeBs. Thus, if a first eNodeB is at capacity (e.g., number of requests or established X2-AP interfaces) and a request is received from a first Home eNodeB, the ranking can be evaluated. If the request from the first Home eNodeB has a higher ranking priority than a current established interface or received request, the first eNodeB can terminate a current established interface or request in order to handle the higher ranking priority request of the Home eNodeB. In still another example, a first eNodeB can be at capacity (e.g., number of requests or established X2-AP interfaces) and a request can be received from a first Home eNodeB, the ranking can be evaluated. If the request from the first Home eNodeB has a lower ranking priority than a current established interface or received request, the first eNodeB can continue the established interface or request in order to deny the lower ranking priority request of the Home eNodeB

The communications apparatus 400 can further include a timer module 408 that can further manage the employment of X2-AP interfaces utilized for data exchange between a Home eNodeB and an eNodeB. In other words, the manager component 404 can manage the initialization, denial, and/or termination of the X2-AP interface based upon the timer module 408, wherein the timer module 408 can define restricted times for connectivity utilizing an X2-AP interface (e.g., based upon high volume times, limited resource periods of time, etc.) and/or an amount of time for connectivity utilizing the X2-AP interface. For example, the timer module 408 can limit periods of the day in which an X2-AP interface can be utilized to exchange data between the HeNB and the eNodeB. Thus, if a request is received during the periods of day in which the X2-AP interface may not be used for data exchange, the request can be denied. In another instance, the timer module 408 can be defined for an amount of time specific to each Home eNodeB, wherein the amount of time allows for a Home eNodeB (upon start up) communicate a request for an X2-AP interface, exchange information, and terminate the connection. If an X2-AP interface is being utilized and the timer module 408 period of time for connectivity expires, the connection can be terminated. It is to be appreciated that the timer module 408 can be defined for any suitable period of time in order to optimally manage the period and capacity of the eNodeB and number of interfaces that can be handled. For example, the timer values can be dependent on the type of node (e.g., macro, Femto, etc.). Moreover, the timer values can be based upon a profile stored per eNB/HeNB basis.

Moreover, although not shown, it is to be appreciated that communications apparatus 400 can include memory that retains instructions with respect to receiving a request from a Home eNodeB upon a start up of the Home eNodeB, denying the request based upon at least one of a timer evaluation or a maximum number of X2-AP connections being met or reached, initializing an X2-AP interface over Stream Control Transmission Protocol (SCTP) based upon the request and/or determination, utilizing the X2-AP interface to exchange data between the Home eNodeB and an eNodeB, terminating the X2-AP interface based upon at least one of a timer evaluation or a maximum number of X2-AP connections for the eNodeB, and the like. Further, communications apparatus 400 can include a processor that may be utilized in connection with executing instructions (e.g., instructions retained within memory, instructions obtained from a disparate source, . . . ).

Additionally, although not shown, it is to be appreciated that communications apparatus 400 can include memory that retains instructions with respect to transmitting a request to an eNodeB upon a start up of the Home eNodeB, receiving a denial for the request based upon a determination of the eNB having a maximum number of X2-AP connections or by evaluating a timer, initializing an X2-AP interface over a Stream Control Transmission Protocol (SCTP) based upon the request and determination of the eNB not having a maximum number of X2-AP connections or evaluation of a timer, utilizing the X2-AP interface to exchange data between a Home eNodeB and the eNodeB, terminating the X2-AP interface based upon at least one of a timer evaluation or a maximum number of X2-AP connections for the eNodeB, and the like. Further, communications apparatus 400 can include a processor that may be utilized in connection with executing instructions (e.g., instructions retained within memory, instructions obtained from a disparate source, . . . ).

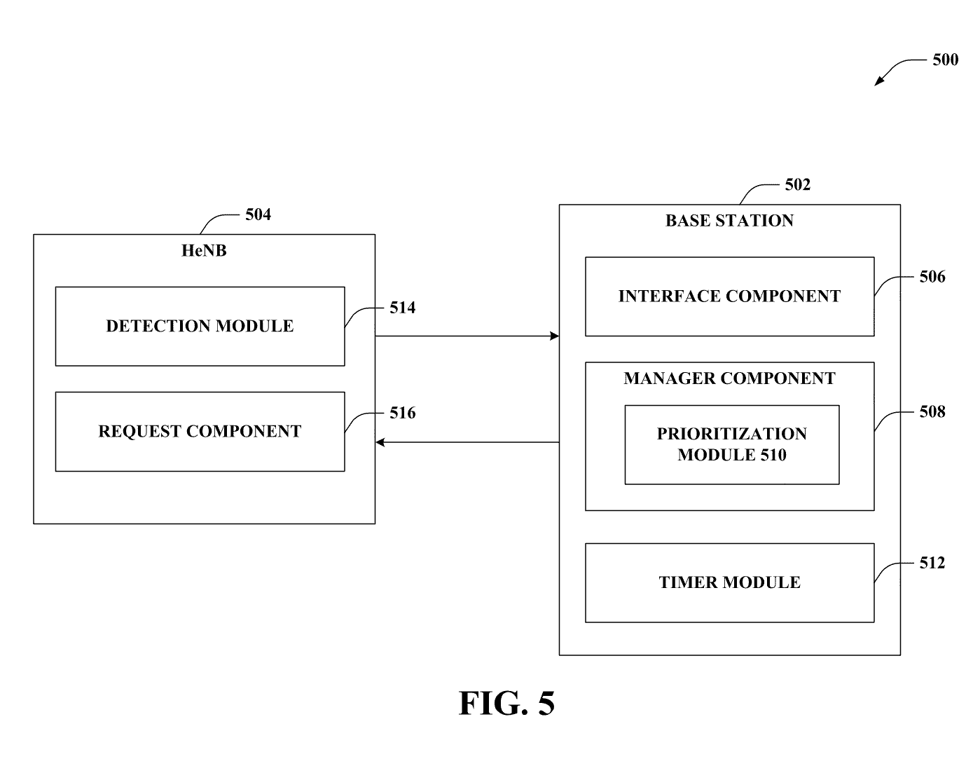

Now referring to FIG. 5, illustrated is a wireless communications system 500 that facilitates utilizing an interface to exchange data between a Home eNodeB (HeNB) and a base station. The system 500 includes a base station 502 that communicates with a HeNB 504 (and/or any number of disparate Home eNB (not shown)). Base station 502 can transmit information to HeNB 504; further base station 502 can receive information from HeNB 504. Moreover, system 500 can be related to a MIMO system. Additionally, the system 500 can operate in an OFDMA wireless network, a 3GPP LTE wireless network, etc. Also, the components and functionalities shown and described below in the base station 502 can be present in the HeNB 504 as well and vice versa, in one example; the configuration depicted excludes these components for ease of explanation. It is to be appreciated that the HeNB 504 can be a Home NodeB, a Home eNodeB, a Home Base station, and the like. Additionally, it is to be appreciated that the base station 502 can be an eNodeB, a NodeB, a macro cell, and the like.

Base station 502 includes an interface component 506 that can include an X2-AP interface that enables data communication between two or more eNodeBs. It is to be appreciated that the subject innovation leverages the X2-AP interface and extends such data exchange capabilities to include data communication between an eNodeB (e.g., base station 502) and the HeNB 504. The base station 502 can further include a manager component 508 that can administrate the implementation and/or use of an X2-AP interface (based upon receipt of a request for the X2-AP interface exposure) for data communication between the HeNB 504 and the base station 502. In particular, the manager component 508 can manage the initialization, denial, or termination of connections with the X2-AP interface based upon a number of requests handled by the base station 502 or a timer evaluation (discussed below). In other words, the subject innovation can evaluate a timer and/or a maximum number of X2-AP connections and deny a request. Moreover, the subject innovation can terminate an existing X2-AP connection in order to establish an X2-AP interface based upon defined priorities (discussed below).

The manager component 508 can further include a prioritization module 510 that can evaluate priority rankings for an eNB (e.g., base station) or a Home eNodeB in order to optimize the exposure of X2-AP interfaces. By utilizing a ranking technique, the base station 502 can optimally expose and initiate X2-AP interfaces for base station requests and/or Home eNodeB requests.

The base station 502 can further include a timer module 512 that can be utilized to manage the X2-AP interface connection for data exchange. The timer module 512 can define periods in which an X2-AP interface may not be employed based on such time periods being busy, low on resources, etc. The timer module 512 can further define a period of time that an X2-AP interface can be utilized between an eNB and a HeNB. Thus, a request can be denied if the evaluation of the timer module 512 indicates a restricted time period. Moreover, an X2-AP interface can be terminated if the evaluation of the timer module 512 indicates that connectivity time has expired. In other words, the timer module 512 can be an amount of time that an initiated X2-AP interface can be open or connected to the base station 502. Thus, the amount of time defined by the timer module 512 for duration of connectivity with the X2-AP interface can be set based upon any suitable factor related to the base station 502 and/or the HeNB 504. For example, the time duration can relate to a minimum amount of time for the HeNB 504 to exchange data using the X2-AP interface.

HeNB 504 can include a detection module 514 that can identify a start up of the HeNB 514. For example, the detection module 514 can identify the implementation of ANR which can reflect a start up of the HeNB 514. The HeNB 504 can further include a request component 516 that can communicate a request to the base station 502 for an X2-AP interface for data exchange. The request component 516 can further receive acknowledgement that such X2-AP interface has been employed from the base station 502, wherein data exchange can be provided by such interface. It is to be appreciated that the acceptance of the request is dependent upon the timer evaluation and the maximum number of X2-AP connections. Moreover, the request component 516 can receive a denial of the request based upon the determination of the eNB related to at least one of a timer evaluation or a maximum number of X2-AP connections.

The subject innovation can allow an HeNB to set up X2-AP interfaces over SCTP to a macro eNB on demand, and then tear down the connection. Moreover, the macro eNBs can be allowed to accept a limited number of X2-AP connections from HeNBs. For instance, the system 500 can enable: the tearing down (e.g., termination) these connections when timer expires; not accepting any more connections if a limit is reached; and tearing down some of these connections if other (more important) connection need the resources like SCTP associations and streams. Moreover, the subject innovation can support X2-AP connections over UDP for HeNBs and/or eNodeBs.

In the wireless communications, the X2-AP is an interface between eNBs. Operations during which this interface is used can be, for example, by the eNBs to share information during ANR (Automatic Neighbor Relation) or for handover of a UE from one eNB to another. In order to perform such operations, an eNB can set up and maintain an X2-AP interface with neighboring eNBs.

It is to be appreciated that the subject innovation manages scalability concerns in light of communication networks supporting numerous HeNBs in a vicinity of a single macro eNB. As such, the macro cell may hand over an UE to any one of these HeNBs, and may need to maintain neighbor relations with all of them. Consequently, the macro cell may use separate X2 interfaces to each neighboring HeNB.

The number of X2-AP connections may not scale since they are carried over a stateful SCTP protocol. It is expensive for the macro eNB to maintain a separate SCTP connection to each neighboring HeNB. Thus, while it could be useful to support X2-AP connections from the macro eNB to the HeNBs, and between all HeNBs, transport limitations may complicate the implementation.

The subject innovation overcomes the limitations imposed in maintaining a large number of X2-AP connections between a macro eNB and a HeNBs. The HeNBs can follow the following steps: set up of X2-AP connections with a neighboring macro cell (eNodeB) on demand, over SCTP (e.g., the HeNB to perform ANR when it is starting up); exchange the required information over X2-AP; and tear down the X2-AP and underlying SCTP connection.

The subject innovation ensures macro eNB is not required to maintain any large number of X2-AP connections. Since these requests ought to appear at random, the macro eNB can scale as long as the frequency is low. This functionality is ideally suited for the HeNBs to perform initial and periodic Self Organizing Networks (SON) functions like Automatic Neighbor Relation (ANR).

The macro eNB can be configured with algorithms to protect itself from being overloaded with such X2-AP requests for HeNBs. For example, the eNB can provide the following: tearing down connections when timer expires; not accepting a connection if a limit is reached; and tearing down some of these connections if other (more important) connections need the resources like SCTP associations and streams.

Moreover, the absence of a persistent X2-AP to a neighbour may not enable optimized X2-AP-based handover to occur. In such a case, the eNBs can rely on S1-based handover.

Given that HeNBs have low power and hence a limited range, HeNBs are expected to have only a few other HeNB neighbors. As such, they may use temporary X2 connections with these neighbors, or maintain perpetual connections with other HeNB neighbors. Additionally, HeNBs may also support X2-AP interfaces over UDP in order to make it more scalable.

Within wireless communications (e.g., LTE, etc.) eNBs can communicate with each other over the X2-AP interface. Since the X2-AP interface is carried over a stateful SCTP protocol, it is difficult for a macro eNB to maintain such X2-AP connections to all its HeNB neighbors. The subject innovation enables the HeNBs to set up temporary X2-AP connections with the macro eNB neighbors in order to perform initial/periodic SON operations like ANR. By this method, the macro eNB is not inundated by X2-AP requests, yet the SON functionalities may be utilized efficiently.

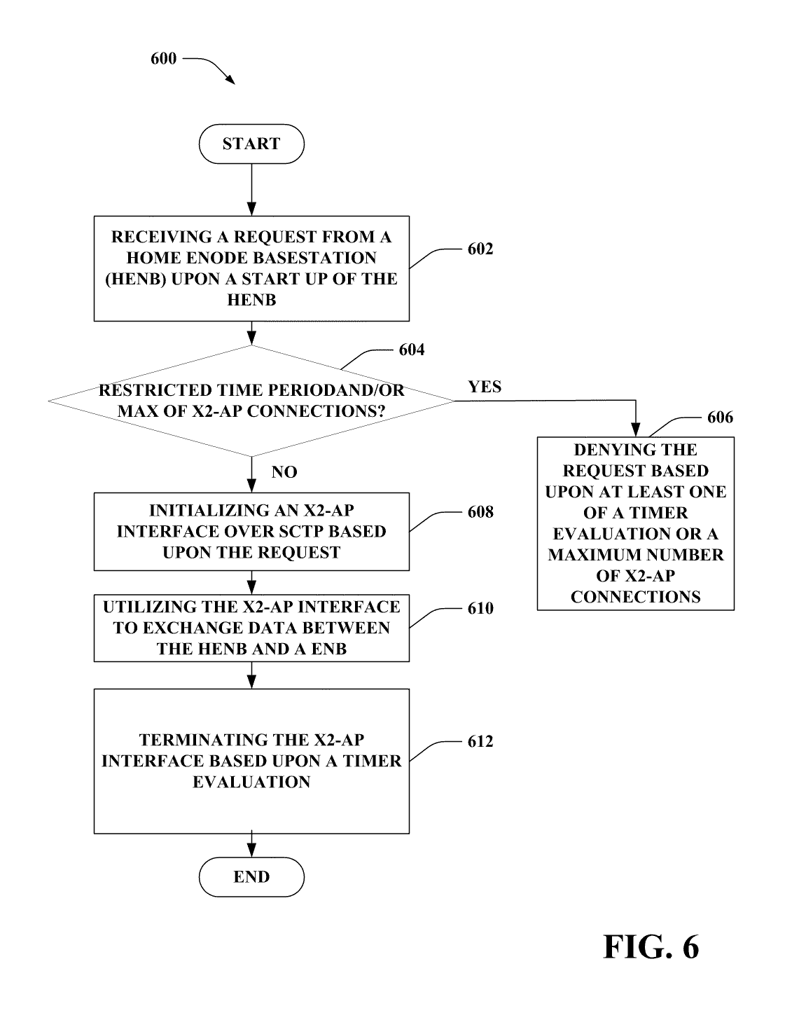

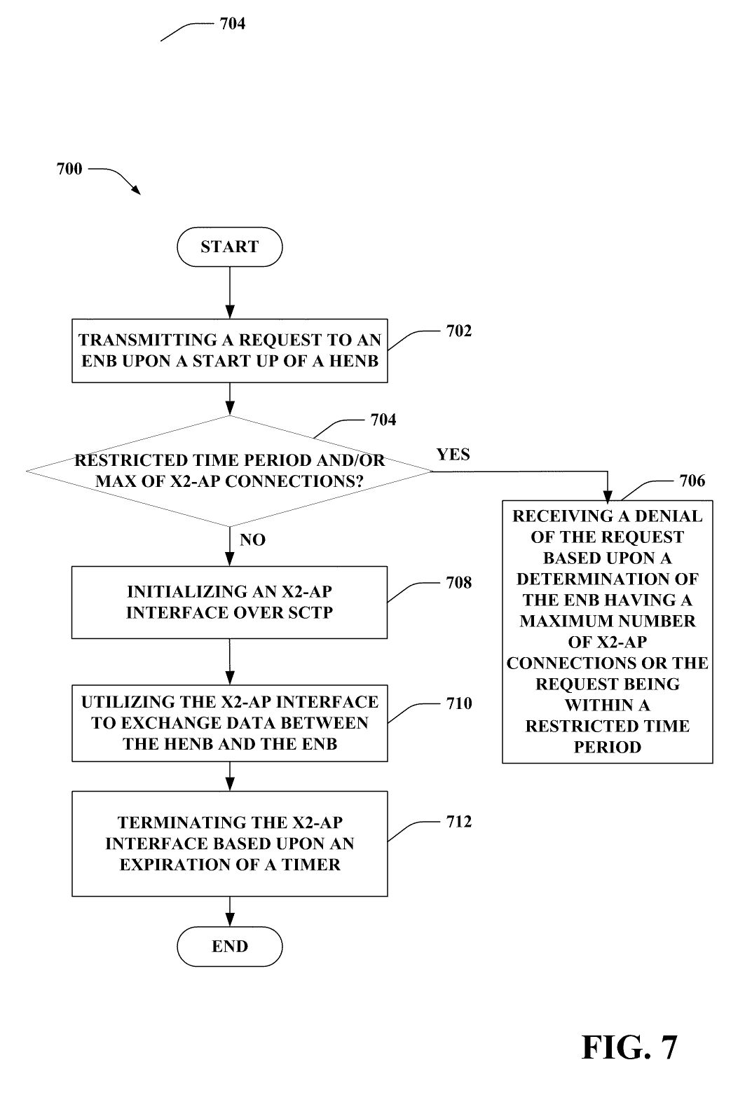

Referring to FIGS. 6-7, methodologies relating to utilizing an interface to exchange data between a Home eNodeB and a base station are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

Turning to FIG. 6, illustrated is a methodology 600 that facilitates initializing an X2-AP interface over SCTP based upon a received request. At reference numeral 602, a request from a Home eNodeB can be received upon a start up of the Home eNodeB. In other words, upon initialization of the Home eNodeB, a request can be communicated and received at an eNodeB. At reference numeral 604, a determination is made whether a request is received at a restricted time and/or a maximum number of X2-AP connections has been reached. If the request is received at a restricted time and/or the maximum number of X2-AP connections has been reached, the method 600 can continue at reference numeral 606. If the timer has not expired and/or the maximum number of X2-AP connections has not been reached, the method 600 can continue at reference numeral 608. At reference numeral 606, the request can be denied based upon at least one of a timer evaluation (e.g., a request is received at a time period that prohibits the use of an X2-AP interface) or a maximum number of X2-AP connections being met or reached. At reference numeral 608, an X2-AP interface can be employed or initialized over Stream Control Transmission Protocol (SCTP) based upon the request. At reference numeral 610, the X2-AP interface can be utilized to exchange data between the Home eNodeB and the eNodeB. At reference numeral 612, the X2-AP interface can be terminated based upon at least one of a timer evaluation. The evaluation of the timer can ensure that the X2-AP interface is open for a defined period of time. Thus, if the timer is expired, the X2-AP interface can be terminated. If the timer is not expired, the X2-AP interface can continue data exchange. For example, the timer can be defined for an amount of time in which the Home eNodeB can start up, communicate a request for the X2-AP interface, exchange data, and disconnect.

In another example, the number of requests can be defined based upon resources available for the eNodeB. Moreover, the number of requests can be adjusted based on a priority listing of eNodeBs and/or Home eNodeBs. For instance, if a maximum number of requests are met for an eNodeB, a particular connection request (e.g., an request from an eNodeB, etc.) can be of a higher priority and thus accepted while another is dropped or terminated based on having a lower priority. In another instance, if a maximum number of requests are met for an eNodeB, a particular Home eNodeB having higher priority can request the X2-AP interface with such eNodeB. In this case, since the Home eNodeB is a higher priority than the Home eNodeBs currently utilizing the X2-AP interface, the higher priority Home eNodeB can be accepted while another of lower priority is dropped or terminated. In other words, in regards to having a number of connections specified, the subject innovation can employ a priority listing for the Home eNodeBs and/or the eNodeBs.

Now referring to FIG. 7, a methodology 700 that leverages an X2-AP interface to communicate data between a HeNB and an eNB. At reference numeral 702, a request can be transmitted to an eNodeB upon a start up of a Home eNodeB. At reference numeral 704, a determination is made whether the request is transmitted during a restricted time period and/or a maximum number of X2-AP connections exists. If the request is transmitted during a restricted time period, the methodology 700 continues at reference numeral 706. If the maximum number of X2-AP connections is met or reached, the methodology continues at reference numeral 706. If the request is not transmitted at a restricted time period and the maximum number of X2-AP connection is not met or reached, the methodology 700 continues at reference numeral 708. At reference numeral 706, a denial can be received for the request based upon a determination of the eNB having a maximum number of X2-AP connections or the request being transmitted during a restricted time period in which X2-AP interface requests are prohibited. At reference numeral 708, an X2-AP interface can be initialized over Stream Control Transmission Protocol (SCTP). At reference numeral 710, the X2-AP interface can be utilized to exchange data between the Home eNodeB and the eNodeB. At reference numeral 712, the X2-AP interface can be terminated based upon an expiration of a timer that defines an amount of time an X2-AP interface can be active to exchange data between the eNB and the HeNB.

For example, the timer can be specifically defined for each Home eNodeB and/or eNodeB. Thus, an eNodeB can, based on specific characteristics related thereto, utilize a timer based on location, available resources, etc. Additionally, each Home eNodeB can utilize a specific timer based on characteristics (e.g., brand, type, connection, location, etc.). In still another example, the eNodeB can leverage a prioritization technique in order to optimally utilize X2-AP interface connections. For example, Home eNodeBs and eNodeBs can each respectively include a priority ranking wherein an eNodeB can evaluate each priority ranking in determining whether or not to initialize or terminate an X2-AP interface connection. Thus, if a number of connections is reached, the priority ranking can be evaluated in order to determine whether a current connection shall be terminated and/or denied for a new request.

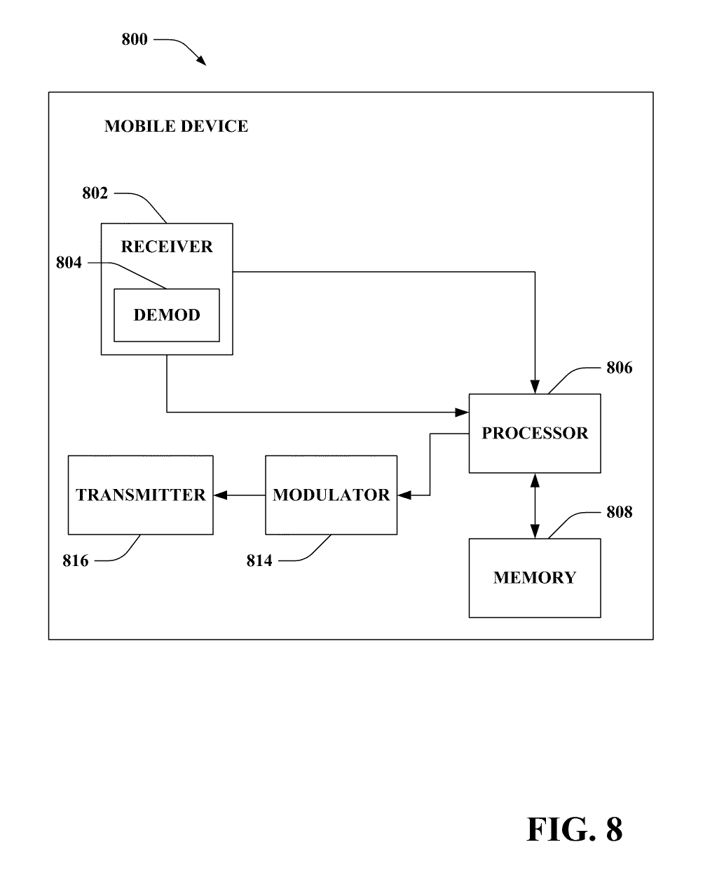

FIG. 8 is an illustration of a mobile device 800 that facilitates acquiring and utilizing timing adjustments. Mobile device 800 comprises a receiver 802 that receives a signal from, for instance, a receive antenna (not shown), performs typical actions on (e.g., filters, amplifies, downconverts, etc.) the received signal, and digitizes the conditioned signal to obtain samples. Receiver 802 can comprise a demodulator 804 that can demodulate received symbols and provide them to a processor 806 for channel estimation. Processor 806 can be a processor dedicated to analyzing information received by receiver 802 and/or generating information for transmission by a transmitter 816, a processor that controls one or more components of mobile device 800, and/or a processor that both analyzes information received by receiver 802, generates information for transmission by transmitter 816, and controls one or more components of mobile device 800.

Mobile device 800 can additionally comprise memory 808 that is operatively coupled to processor 806 and that can store data to be transmitted, received data, information related to available channels, data associated with analyzed signal and/or interference strength, information related to an assigned channel, power, rate, or the like, and any other suitable information for estimating a channel and communicating via the channel. Memory 808 can additionally store protocols and/or algorithms associated with estimating and/or utilizing a channel (e.g., performance based, capacity based, etc.).

It will be appreciated that the data store (e.g., memory 808) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 808 of the subject systems and methods is intended to comprise, without being limited to, these and any other suitable types of memory.

Mobile device 800 still further comprises a modulator 814 and transmitter 816 that respectively modulate and transmit signals to, for instance, a base station, another mobile device, etc. Although depicted as being separate from the processor 806, it is to be appreciated that the demodulator 804, and/or modulator 814 can be part of the processor 806 or multiple processors (not shown).

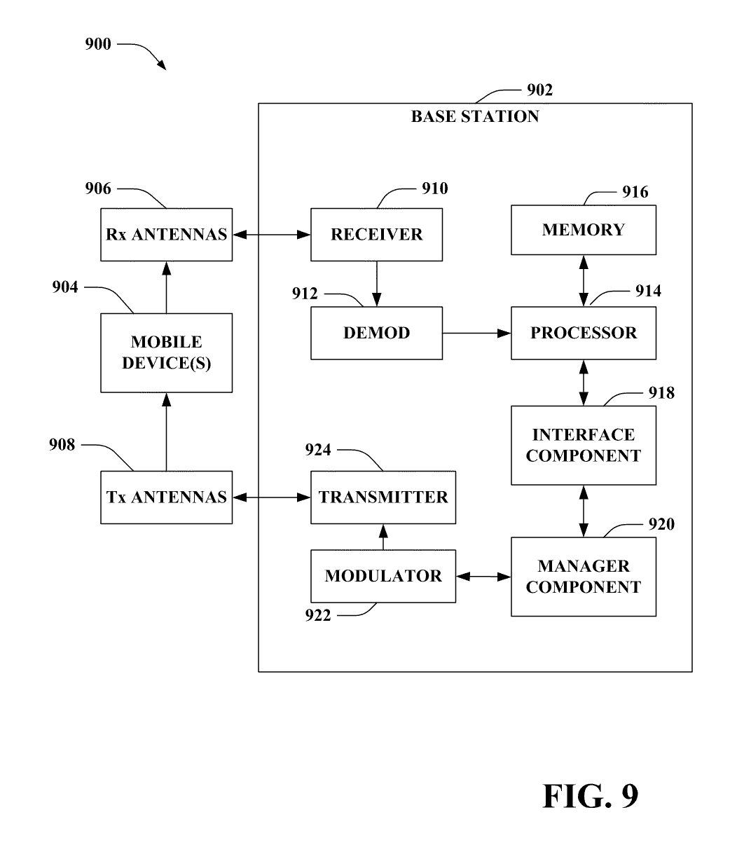

FIG. 9 is an illustration of a system 900 that facilitates evaluating, transmitting and receiving timing updates for uplink channels as described supra. The system 900 comprises a base station 902 (e.g., access point, . . . ) with a receiver 910 that receives signal(s) from one or more mobile devices 904 through a plurality of receive antennas 906, and a transmitter 924 that transmits to the one or more mobile devices 904 through a transmit antenna 908. Receiver 910 can receive information from receive antennas 906 and is operatively associated with a demodulator 912 that demodulates received information. Demodulated symbols are analyzed by a processor 914 that can be similar to the processor described above with regard to FIG. 8, and which is coupled to a memory 916 that stores information related to estimating a signal (e.g., pilot) strength and/or interference strength, data to be transmitted to or received from mobile device(s) 904 (or a disparate base station (not shown)), and/or any other suitable information related to performing the various actions and functions set forth herein.

Moreover, the processor 914 can be coupled to at least one of an interface component 918 or a manager component 920. The interface component 918 can employ an X2-AP interface for data exchange between an eNodeB and a disparate eNodeB or between an eNodeB and a Home eNodeB. The manager component 920 can administrate employment and exposure of the X2-AP interface based at least upon a timer evaluation or a number of requests/connections to the eNodeB. For example, the timer can provide time periods in which an X2-AP interface connection is prohibited and/or allowed. During such restricted time periods, the request for an X2-AP interface can be denied. Moreover, a request can be denied if a maximum number of X2-AP interface connections are active between the eNB and the HeNB. In general, the manager component 920 can deny a request for an X2-AP interface based upon a maximum number of X2-AP connections being active. Additionally, the manager component 920 can allow the X2-AP connection to be made. Moreover, the manager component 920 can terminate an active X2-AP connection based upon a timer expiration (e.g., a timer that defines an amount of time duration that an X2-AP connection can exist) and/or a request from an HeNB or eNB with a higher priority. Furthermore, although depicted as being separate from the processor 914, it is to be appreciated that the interface component 918, manager component 920, demodulator 912, and/or modulator 922 can be part of the processor 914 or multiple processors (not shown).

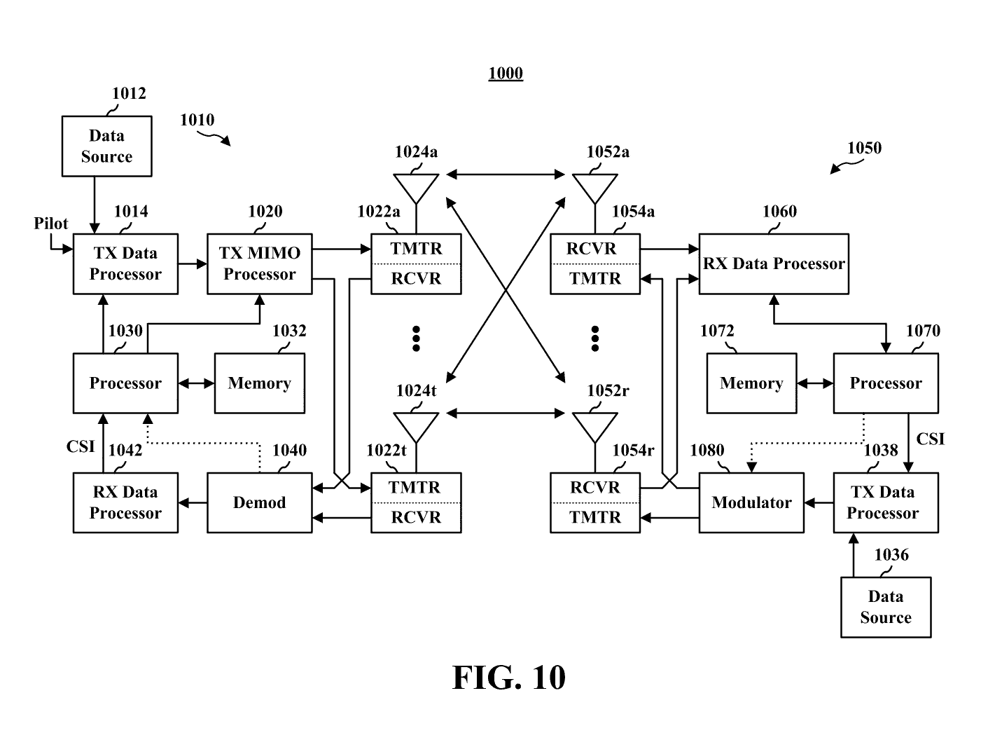

FIG. 10 shows an example wireless communication system 1000. The wireless communication system 1000 depicts one base station 1010 and one mobile device 1050 for sake of brevity. However, it is to be appreciated that system 1000 can include more than one base station and/or more than one mobile device, wherein additional base stations and/or mobile devices can be substantially similar or different from example base station 1010 and mobile device 1050 described below. In addition, it is to be appreciated that base station 1010 and/or mobile device 1050 can employ the systems (FIGS. 1-5 and 8-9), and/or methods (FIGS. 6-7) described herein to facilitate wireless communication there between.

At base station 1010, traffic data for a number of data streams is provided from a data source 1012 to a transmit (TX) data processor 1014. According to an example, each data stream can be transmitted over a respective antenna. TX data processor 1014 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1050 to estimate channel response. The multiplexed pilot and coded data for each data stream can be modulated (e.g. symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1030.

The modulation symbols for the data streams can be provided to a TX MIMO processor 1020, which can further process the modulation symbols (e.g., for OFDM). TX MIMO processor 1020 then provides N_{T} modulation symbol streams to N_{T} transmitters (TMTR) 1022a through 1022t. In various embodiments, TX MIMO processor 1020 applies beamforming weights to the symbols of the data streams and to the antenna from which the symbol is being transmitted.

Each transmitter 1022 receives and processes a respective symbol stream to provide one or more analog signals, and further conditions (e.g. amplifies, filters, and upconverts) the analog signals to provide a modulated signal suitable for transmission over the MIMO channel. Further, N_{T} modulated signals from transmitters 1022a through 1022t are transmitted from N_{T} antennas 1024a through 1024t, respectively.

At mobile device 1050, the transmitted modulated signals are received by N_{R} antennas 1052a through 1052r and the received signal from each antenna 1052 is provided to a respective receiver (RCVR) 1054a through 1054r. Each receiver 1054 conditions (e.g., filters, amplifies, and downconverts) a respective signal, digitizes the conditioned signal to provide samples, and further processes the samples to provide a corresponding “received” symbol stream.

An RX data processor 1060 can receive and process the N_{R} received symbol streams from N_{R} receivers 1054 based on a particular receiver processing technique to provide N_{T} “detected” symbol streams. RX data processor 1060 can demodulate, deinterleave, and decode each detected symbol stream to recover the traffic data for the data stream. The processing by RX data processor 1060 is complementary to that performed by TX MIMO processor 1020 and TX data processor 1014 at base station 1010.

A processor 1070 can periodically determine which precoding matrix to utilize as discussed above. Further, processor 1070 can formulate a reverse link message comprising a matrix index portion and a rank value portion.

The reverse link message can comprise various types of information regarding the communication link and/or the received data stream. The reverse link message can be processed by a TX data processor 1038, which also receives traffic data for a number of data streams from a data source 1036, modulated by a modulator 1080, conditioned by transmitters 1054a through 1054r, and transmitted back to base station 1010.

At base station 1010, the modulated signals from mobile device 1050 are received by antennas 1024, conditioned by receivers 1022, demodulated by a demodulator 1040, and processed by a RX data processor 1042 to extract the reverse link message transmitted by mobile device 1050. Further, processor 1030 can process the extracted message to determine which precoding matrix to use for determining the beamforming weights.

Processors 1030 and 1070 can direct (e.g., control, coordinate, manage, etc.) operation at base station 1010 and mobile device 1050, respectively. Respective processors 1030 and 1070 can be associated with memory 1032 and 1072 that store program codes and data. Processors 1030 and 1070 can also perform computations to derive frequency and impulse response estimates for the uplink and downlink, respectively.

It is to be understood that the embodiments described herein can be implemented in hardware, software, firmware, middleware, microcode, or any combination thereof For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

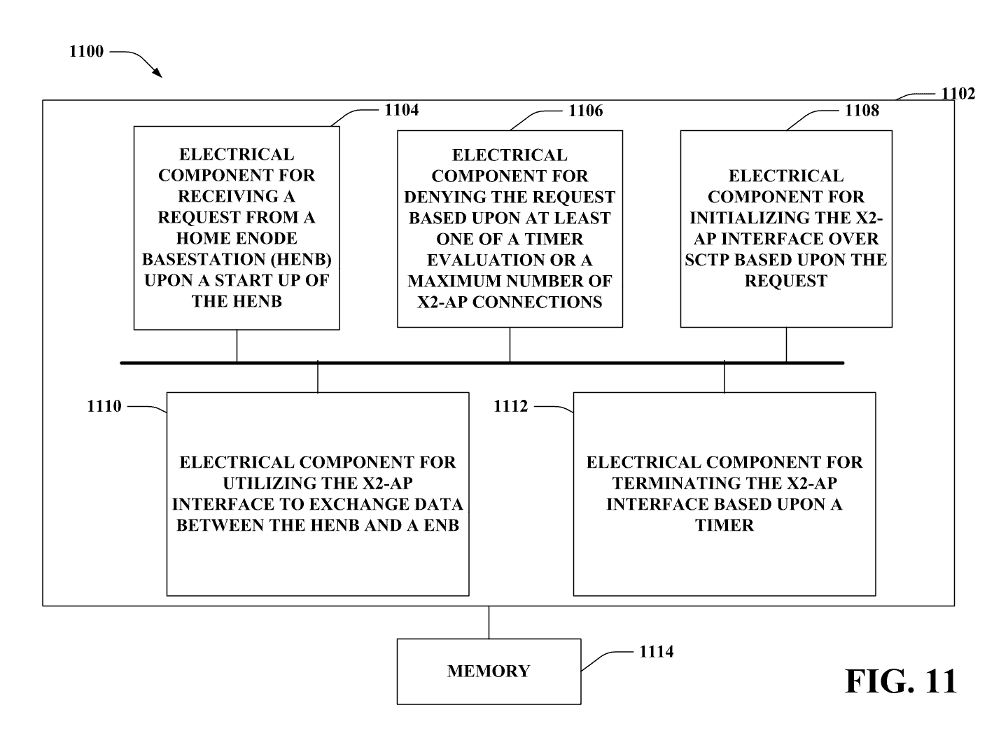

With reference to FIG. 11, illustrated is a system 1100 that manages an X2-AP interface for data exchange between a HeNB and an eNB. For example, system 1100 can reside at least partially within a base station, eNodeB, NodeB, HeNB, HomeNB, mobile device, etc. It is to be appreciated that system 1100 is represented as including functional blocks, which can be functional blocks that represent functions implemented by a processor, software, or combination thereof (e.g., firmware). System 1100 includes a logical grouping 1102 of electrical components that can act in conjunction. The logical grouping 1102 can include an electrical component for receiving a request from a Home eNode Basestation (HeNB) upon a start up of the HeNB 1104. The logical grouping 1102 can include an electrical component for denying the request based upon at least one of a timer evaluation or a maximum number of X2-AP connections for the eNB 1106. In addition, the logical grouping 1102 can comprise an electrical component for initializing an X2-AP interface over Stream Control Transmission Protocol (SCTP) based upon the request 1108. It is to be appreciated that the X2-AP interface is initialized based upon the timer evaluation and/or the maximum number of X2-AP connections. Thus, if a request is made during a restricted time period and/or the maximum number of X2-AP connections is met, the request is denied. Yet, if the request is made during an allowed time period and the maximum number of connections is not met, the X2-AP interface can be initialized and utilized. Moreover, the logical grouping 1102 can include an electrical component for utilizing the X2-AP interface to exchange data between the HeNB and an eNB 1110. The logical grouping 1102 can comprise an electrical component for terminating the X2-AP interface based upon an expiration of a timer that defines an amount of time an X2-AP interface can be active to exchange data between the eNB and the HeNB 1112. Additionally, system 1100 can include a memory 1114 that retains instructions for executing functions associated with electrical components 1104, 1106, 1108, 1110, and 1112. While shown as being external to memory 1114, it is to be understood that one or more of electrical components 1104, 1106, 1108, 1110, and 1112 can exist within memory 1114.

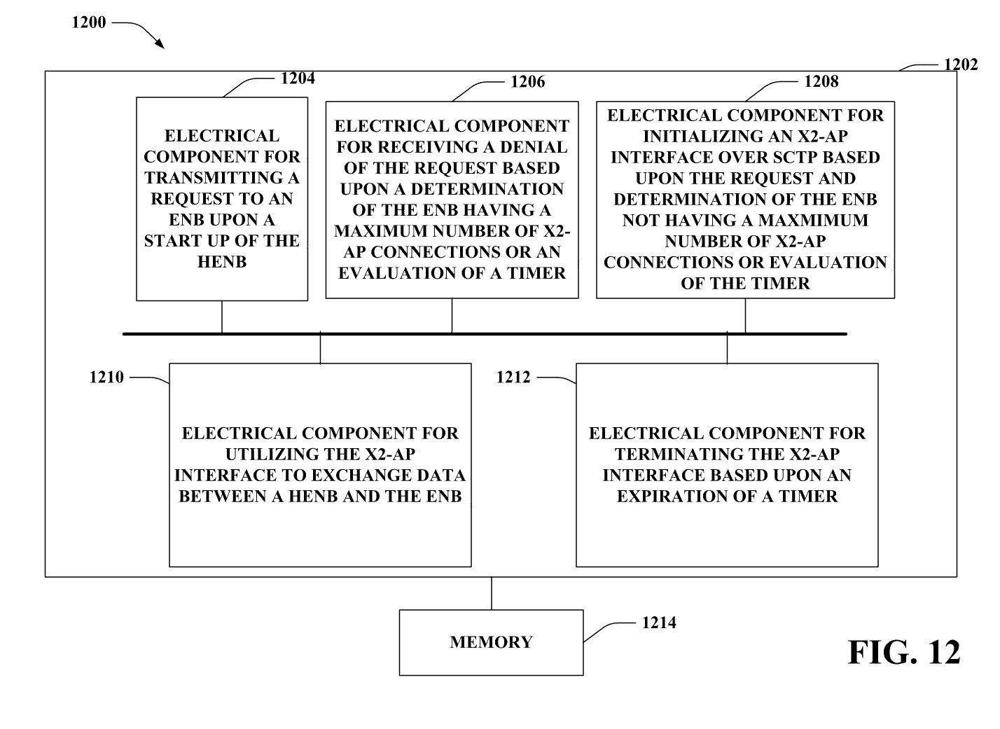

Turning to FIG. 12, illustrated is a system 1200 that employs an X2-AP interface for data exchange based upon a transmitted request in a wireless communications network. System 1200 can reside within a base station, eNodeB, NodeB, HeNB, HomeNB, mobile device, etc., for instance. As depicted, system 1200 includes functional blocks that can represent functions implemented by a processor, software, or combination thereof (e.g. firmware). Logical grouping 1202 can include an electrical component for transmitting a request to an eNB upon a start up of the HeNB 1204. Logical grouping 1202 can include an electrical component for receiving a denial for the request based upon a determination of the eNB having a maximum number of X2-AP connections or an evaluation of a timer 1206. Moreover, logical grouping 1202 can include an electrical component for initializing an X2-AP interface over SCTP based upon the request and the determination of the eNB not having the maximum number of X2-AP connections or evaluation of the timer 1208. It is to be appreciated that the X2-AP interface is initialized based upon the timer evaluation and/or the maximum number of X2-AP connections. Thus, if a request is made during a restricted time period and/or the maximum number of X2-AP connections is met, the request is denied. Yet, if the request is made during an allowed time period and the maximum number of connections is not met, the X2-AP interface can be initialized and utilized. Further, logical grouping 1202 can comprise an electrical component for utilizing the X2-AP interface to exchange data between a HeNB and the eNB 1210. In addition, logical grouping 1202 can include an electrical component for terminating the X2-AP interface based upon an expiration of a timer that defines an amount of time an X2-AP interface can be active to exchange data between the eNB and the HeNB 1212. Additionally, system 1200 can include a memory 1214 that retains instructions for executing functions associated with electrical components 1204, 1206, 1208, 1210, and 1212. While shown as being external to memory 1214, it is to be understood that electrical components 1204, 1206, 1208, 1210, and 1212 can exist within memory 1214.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method used in a wireless communications system that facilitates utilizing an interface to exchange data, comprising:
receiving an on demand request from an access point base station upon a start up of the access point base station, wherein the request relates to initiating an interface to exchange data;
denying the request based upon at least one of a resource constraint or a timer constraint; and
utilizing an interface to exchange data between the access point base station and an access terminal when at least one of the resource constraint or the timer constraint are met.

2. The method of claim 1, wherein the resource constraint is a maximum number of connections the access terminal handles and the timer constraint relates to a timer evaluation.

3. The method of claim 2, wherein the request is denied based upon at least one of a timer evaluation or a maximum number of connections being met or reached.

4. The method of claim 2, wherein the request is accepted when the maximum number of connections is not reached and the timer evaluation indicates the received request is within an allowed time period.

5. The method of claim 2, wherein the interface is an X2-Application Protocol (X2-AP) interface.

6. The method of claim 2, further comprising terminating the interface based upon an expiration of a timer that defines an amount of time the interface can be active to exchange data.

7. The method of claim 2, further comprising initializing the interface over Stream Control Transmission Protocol (SCTP) based upon the maximum number of connection not being met.

8. The method of claim 2, wherein the timer evaluation that indicates the received request is within an allowed time period.

9. The method of claim 1, further comprising utilizing the interface over UDP to improve scalablity for at least one of the access point base station or the access terminal.

10. The method of claim 1, wherein a timer defines an amount of time the interface is utilized to connect and exchange data between the access point base station and the access terminal.

11. The method of claim 10, further comprising calculating the timer as a function of at least one of a type of node, or on a per-node basis.

12. The system of claim 1, further comprising:
ranking at least one of an access terminal or an access point base station with a priority ranking;
evaluating a priority ranking from a requesting access terminal or a requesting access point base station;
examining a priority ranking related to at least one of a connected access terminal or a connected access point base station that is utilizing at least one interface; and
terminating at least one interface utilized by at least one of the connected access terminal or the connected access point base station if the priority ranking of at least one of the requesting access terminal or the requesting access point base station is higher than the priority ranking of at least one of the connected access terminal or the connected access point base station.

13. The system of claim 12, further comprising denying at least one of the requesting access terminal or the requesting access point base station if the priority ranking is lower than the priority ranking of at least one of the connected access terminal or the connected access point base station.

14. The system of claim 12, further comprising utilizing a priority ranking based upon a source of the request, wherein the source of the request is at least one of an access terminal or an access point base station.

15. A wireless communications apparatus, comprising:
at least one processor configured to:
receive a request from an access point base station upon a start up of the access point base station, wherein the request relates to initiating an interface to exchange data;
denying the request based upon at least one of a timer constraint or a resource constraint;
utilizing an interface over Stream Control Transmission Protocol (SCTP) to exchange data between the access point base station and an access terminal when at least one of the resource constraint or the timer constraint are met; and
a memory coupled to the at least one processor.

16. The wireless communications apparatus of claim 15, wherein the interface is an X2-Application Protocol (X2-AP) interface.

17. The wireless communications apparatus of claim 15, further comprising at least one processor configured to:
utilize the interface over UDP to improve scalablity for at least one of the access point base station or the access terminal; and
terminate the interface based upon an expiration of a timer that defines an amount of time the interface can be active to exchange data.

18. The wireless communications apparatus of claim 15, further comprising at least one processor configured to:
rank at least one of an access terminal or an access point base station with a priority ranking;
evaluate a priority ranking from a requesting access terminal or a requesting access point base station;
examine a priority ranking related to at least one of a connected access terminal or a connected access point base station that is utilizing at least one interface; and
terminate at least one interface utilized by at least one of the connected access terminal or the connected access point base station if the priority ranking of at least one of the requesting access terminal or the requesting access point base station is higher than the priority ranking of at least one of the connected access terminal or the connected access point base station.

19. The wireless communications apparatus of claim 15, further comprising at least one processor configured to deny at least one of the requesting access terminal or the requesting access point base station if the priority ranking is lower than the priority ranking of at least one of the connected access terminal or the connected access point base station.

20. A wireless communications apparatus that enables utilization of an interface to exchange data in a wireless communication network, comprising:
means for receiving an on demand request from an access point base station upon a start up of the access point base station, wherein the request relates to initiating an interface to exchange data;
means for denying the request based upon at least one of a timer constraint or a resource constraint; and
means for utilizing an interface to exchange data between the access point base station and an access terminal when the resource constraint and the timer constraint are met.

21. The wireless communications apparatus of claim 20, wherein the resource constraint is a maximum number of connections the access terminal handles and the timer constraint relates to a timer evaluation.

22. The wireless communications apparatus of claim 21, wherein the request is denied based upon at least one of a timer evaluation or a maximum number of connections being met or reached.

23. The wireless communications apparatus of claim 22, wherein the interface is an X2-Application Protocol (X2-AP) interface.

24. The wireless communications apparatus of claim 22, further comprising means for terminating the interface based upon an expiration of a timer that defines an amount of time the interface can be active to exchange data.

25. The wireless communications apparatus of claim 22, further comprising means for initializing the interface over Stream Control Transmission Protocol (SCTP) based upon the maximum number of connection not being met and the timer evaluation that indicates the received request is within an allowed time period.

26. The wireless communications apparatus of claim 22, further comprising means for utilizing the interface over UDP to improve scalablity for at least one of the access point base station or the access terminal.

27. The wireless communications apparatus of claim 22, wherein a timer defines an amount of time the X2-AP interface is utilized to connection and exchange data between the access point base station and the access terminal.

28. The wireless communications apparatus of claim 27, further comprising means for calculating the timer as a function of at least one of a type of node, or on a per-node basis.

29. The wireless communications apparatus of claim 27, further comprising:
means for ranking at least one of an access terminal or an access point base station with a priority ranking;
means for evaluating a priority ranking from a requesting access terminal or a requesting access point base station;
means for examining a priority ranking related to at least one of a connected access terminal or a connected access point base station that is utilizing at least one interface; and
means for terminating at least one interface utilized by at least one of the connected access terminal or the connected access point base station if the priority ranking of at least one of the requesting access terminal or the requesting access point base station is higher than the priority ranking of at least one of the connected access terminal or the connected access point base station.

30. The wireless communications apparatus of claim 29, further comprising means for denying at least one of the requesting access terminal or the requesting access point base station if the priority ranking is lower than the priority ranking of at least one of the connected access terminal or the connected access point base station.

31. The wireless communications apparatus of claim 29, further comprising means for utilizing a priority ranking based upon a source of the request, wherein the source of the request is at least one of an access terminal or an access point base station.

32. A computer program product, comprising:
a computer-readable medium comprising:
code for causing at least one computer to receive a request from an access point base station upon a start up of the access point base station, wherein the request relates to initiating an interface to exchange data;
code for causing at least one computer to deny the request based upon at least one of a timer constraint or a resource constraint; and
code for causing at least one computer to utilizing an interface to exchange data between the access point base station and an access terminal when the timer constraint and the resource constraint are met.

33. The computer program product of claim 32, the computer-readable medium further comprising:
code for causing at least one computer to initialize the interface over Stream Control Transmission Protocol (SCTP) based upon resource constraint of a maximum number of connections not being met and the timer constraint of a timer indicates the received request is within an allowed time period; and
code for causing at least one computer to terminate the interface based upon an expiration of a timer that defines an amount of time the interface can be active to exchange data.

34. The computer program product of claim 32, the computer-readable medium further comprising code for causing at least one computer to utilize the interface over UDP to improve scalablity for at least one of the access point base station or the access terminal.

35. A method used in a wireless communications system that facilitates utilizing an interface to exchange data, comprising:
transmitting a request to an access terminal upon a start up of an access point base station, wherein the request relates to initiating an interface to exchange data;
receiving a denial for the request based upon of at least one of a resource constraint or a timer constraint; and
utilizing an interface over Stream Control Transmission Protocol (SCTP) to exchange data between an access point base station and the access terminal when the resource constraint and the timer constraint are met.

36. The method of claim 35, wherein the resource constraint is a maximum number of connections the access terminal handles and the timer constraint relates to a timer evaluation.

37. The method of claim 36, wherein the request is denied based upon at least one of a timer evaluation or a maximum number of connections being met or reached.

38. The method of claim 36, wherein the request is accepted when the maximum number of connections is not reached and the timer evaluation indicates the received request is within an allowed time period.

39. The method of claim 36, wherein the interface is an X2-Application Protocol (X2-AP) interface.

40. The method of claim 36, further comprising receiving a termination of the interface based upon an expiration of a timer that defines an amount of time the interface can be active to exchange data.

41. The method of claim 36, further comprising initializing the interface over Stream Control Transmission Protocol (SCTP) based upon the maximum number of connection not being met and the timer evaluation that indicates the received request is within an allowed time period.

42. The method of claim 36, further comprising utilizing the interface over UDP to improve scalablity for at least one of the access point base station or the access terminal.

43. The method of claim 36, wherein the timer defines an amount of time the interface is utilized to connect and exchange data between the access point base station and the access terminal.

44. The method of claim 43, further comprising calculating the timer as a function of at least one of a type of node, or on a per-node basis.

45. The method of claim 36, further comprising:
ranking at least one of an access terminal or an access point base station with a priority ranking;
evaluating a priority ranking from a requesting access terminal or a requesting access point base station;
examining a priority ranking related to at least one of a connected access terminal or a connected access point base station that is utilizing at least one interface; and
terminating at least one interface utilized by at least one of the connected access terminal or the connected access point base station if the priority ranking of at least one of the requesting access terminal or the requesting access point base station is higher than the priority ranking of at least one of the connected access terminal or the connected access point base station.

46. The method of claim 45, further comprising denying at least one of the requesting access terminal or the requesting access point base station if the priority ranking is lower than the priority ranking of at least one of the connected access terminal or the connected access point base station.

47. The method of claim 45, further comprising utilizing a priority ranking based upon a source of the request, wherein the source of the request is at least one of an access terminal or an access point base station.

48. A wireless communications apparatus, comprising:
at least one processor configured to:
transmit a request to an access terminal upon a start up of an access point base station, wherein the request relates to initiating an interface to exchange data;
receive a denial for the request based upon at least one of a timer constraint or a resource constraint;
utilize an interface to exchange data between an access point base station and the access terminal when the time constraint and the resource constraint are met; and
a memory coupled to the at least one processor.

49. The wireless communications apparatus of claim 48, further comprising:
at least one processor configured to:
initialize the interface over Stream Control Transmission Protocol (SCTP) based upon the resource constraint of a maximum number of connection not being met and the time constraint of a timer evaluation that indicates the received request is within an allowed time period; and
receive a termination of the interface based upon an expiration of a timer that defines an amount of time the interface can be active to exchange data.

50. The wireless communications apparatus of claim 48, further comprising at least one processor configured to utilize the interface over UDP to improve scalablity for at least one of the access point base station or the access terminal.

51. A wireless communications apparatus that enables employment of an interface to exchange data, comprising:
means for transmitting a request to an access terminal upon a start up of an access point base station, wherein the request relates to initiating an interface to exchange data;
means for receiving a denial for the request based upon at least one of a timer constraint or a resource constraint; and
means for utilizing an interface to exchange data between an access point base station and the access terminal when the maximum number of connection is not reached and the evaluation of the timer indicates the received request is within an allowed time period.

52. The wireless communications apparatus of claim 51, wherein the resource constraint is a maximum number of connections the access terminal handles and the timer constraint relates to a timer evaluation.

53. The wireless communications apparatus of claim 52, wherein the request is denied based upon at least one of a timer evaluation or a maximum number of connections being met or reached.

54. The wireless communications apparatus of claim 52, wherein the request is accepted when the maximum number of connections is not reached and the timer evaluation indicates the received request is within an allowed time period.

55. The wireless communications apparatus of claim 52, further comprising:
means for initializing the interface over Stream Control Transmission Protocol (SCTP) based upon the maximum number of connection not being met and the timer evaluation that indicates the received request is within an allowed time period.

56. The wireless communications apparatus of claim 52, further comprising means for receiving a termination of the interface based upon an expiration of a timer that defines an amount of time the interface can be active to exchange data.

57. The wireless communications apparatus of claim 52, further comprising means for utilizing the interface over UDP to improve scalablity for at least one of the access point base station or the access terminal.

58. The wireless communications apparatus of claim 52, wherein a timer defines an amount of time the X2-AP interface is utilized to connect and exchange data between the access point base station and the access terminal and the interface is an X2-Application Protocol (X2-AP) interface.

59. The wireless communications apparatus of claim 58, further comprising means for calculating the timer as a function of at least one of a type of node, or on a per-node basis.

60. The wireless communications apparatus of claim 52, further comprising:
ranking at least one of an access terminal or an access point base station with a priority ranking;
evaluating a priority ranking from a requesting access terminal or a requesting access point base station;
examining a priority ranking related to at least one of a connected access terminal or a connected access point base station that is utilizing at least one interface; and
terminating at least one interface utilized by at least one of the connected access terminal or the connected access point base station if the priority ranking of at least one of the requesting access terminal or the requesting access point base station is higher than the priority ranking of at least one of the connected access terminal or the connected access point base station.

61. The wireless communications apparatus of claim 60, further comprising denying at least one of the requesting access terminal or the requesting access point base station if the priority ranking is lower than the priority ranking of at least one of the connected access terminal or the connected access point base station.

62. The wireless communications apparatus of claim 60, further comprising utilizing a priority ranking based upon a source of the request, wherein the source of the request is at least one of an access terminal or an access point base station.

63. A computer program product, comprising:
a computer-readable medium comprising:
code for causing at least one computer to transmit a request to an access terminal upon a start up of an access point base station, wherein the request relates to initiating an interface to exchange data;
code for causing at least one computer to receive a denial for the request based upon at least one of a timer constraint or a resource constraint; and
code for causing at least one computer to utilize an interface over Stream Control Transmission Protocol (SCTP) to exchange data between an access point base station and the access terminal when the resource constraint and the timer constraint are met.
